(19) United States
(12) Patent Application Publication
(10) Pub. No.: US 2014/0013734 A1
(43) Pub. Date: Jan. 16, 2014

(54) MECHANICAL SEAL SUPPORT SYSTEM

(71) Applicants: Christopher Glyn Booth, Barnsley (GB); Andrew Thomas Freeman, Manchester (GB)

(72) Inventors: Christopher Glyn Booth, Barnsley (GB); Andrew Thomas Freeman, Manchester (GB)

(73) Assignee: AES Engineering Limited, Rotherham (GB)

(21) Appl. No.: 13/839,970

(22) Filed: Mar. 15, 2013

(30) Foreign Application Priority Data
Mar. 15, 2012 (GB) 1204641.3

(51) Int. Cl. F15B 13/16

(52) U.S. Cl. CPC F15B 13/16
USPC 60/328

(57) ABSTRACT

A mechanical seal support system includes a bladder accumulator and a device for generating an electrical signal responsive to the temperature and pressure within the bladder accumulator and for generating an electrical signal indicative of the volume of a liquid in the accumulator. A display device receives the signal and provides a visual indication of the volume of the liquid.

### BACKGROUND OF THE INVENTION

1. Technical Field of Invention

The present invention relates to a mechanical seal support system for determining the volumetric level of barrier fluid in a mechanical seal pressure vessel.

2. Description of the Prior Art

An API Plan 53B accumulator consists of a pressure vessel with an elastomeric bag inside. The bag is internally pressurized with gas. Liquid is then pumped into the vessel causing the bag to contract and so causing the liquid to occupy the space between the bag and the vessel wall.

Over the course of days and weeks, liquid is lost from the mechanical seal. The bag expands to replace these losses; at the same time the system pressure slowly falls. If the accumulator is allowed to empty of liquid, the bag runs out of room to expand and barrier system pressure is lost. In order to maintain the operating pressure for the mechanical seal the liquid must be replenished before the accumulator becomes empty.

The problem is that there is no visual indication of the liquid level to prompt the operator to refill. The nature of the accumulator design does not allow the level to be monitored by means of a simple level gauge. A pressure switch, or transmitter, is usually fitted, which will raise a “fill-me” alarm based on the liquid pressure. The operator is then required to add liquid by means of a small hydraulic pump until the pressure rises to the “charge pressure.” Thus, the level of liquid fill is inferred from the gas pressure in the bag. However, the gas pressure in the bag is affected by the ambient temperature and so as temperature falls, so does pressure, and vice versa. Between −10° C. and +40° C., the indicated pressure can change by almost 20%. Thus, pressure alone is an inaccurate method to control fill.

The draft edition of API 682 4^{th} edition (IS021049) proposes a 53B system design procedure which takes into account pressure variations due to ambient temperature changes. The result is that if a simple pressure-only “fill-me” alarm is used the working volume of liquid is greatly reduced. This will increase the size of the accumulator required to give an acceptable “hold-up” time between refills. In addition, the required charge pressure, i.e., the pressure in the accumulator when just filled with liquid in the required quantity, is also increased. The standard proposes an alternative “floating alarm”' strategy, wherein the alarm pressure is automatically adjusted according to the actual ambient temperature. This allows a greater working volume of liquid for a given size of accumulator, and also reduces the required charge pressure, thus reducing the stress on the mechanical seal, hence increasing its expected life and reliability.

It would be useful for this “floating alarm” system to provide an indication of the volume of liquid in the accumulator so that it is obvious to the operator when the accumulator requires refilling and also, when refilling it, when it has reached the required pressure.

### SUMMARY OF THE INVENTION

According to the present invention, there is provided a mechanical seal support system comprising:
a. a hydro pneumatic accumulator containing, in use, a liquid;
b. means, responsive to the temperature and pressure within the bladder accumulator, for generating an electrical signal indicative of the volume of said liquid in said accumulator; and,
c. display means, in electrical communication with said signal generating means, for receiving said signal and providing a visual indication relating to the volume of said liquid.

Preferably, the display means provides a visual indication of the point at which the volume liquid within the bladder accumulator reaches a pre-determined low or high level.

Preferably, the low liquid level is indicated via a colored light and the high level is indicated via a coloured light of a differing hue.

More preferably, the low level is indicated by a red light and the high level is indicated by a green light. A second red light may indicate when the pressure has exceeded the maximum operating pressure of the system.

Alternatively, or in addition, the liquid level is indicated via a digital display. The digital display may be arranged to indicate the liquid level as a numerical percentage.

Preferably, the signal generating means is located externally of the accumulator.

Preferably, the system includes pipe work connecting the signal generating means to the accumulator.

Preferably, the signal generating means is mounted on existing fittings in the pipework of an API Plan 53B system.

Preferably, said visual indication means wherein said low liquid level is indicated via a colored light and said high level is indicated via a colored light of a differing hue.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

In the drawing, wherein similar reference numerals and symbols denote similar features throughout the several views:

FIG. 1 illustrates the API Plan 53B seal support system not incorporating the present invention;

FIG. 2 is a more detailed view of the seal support system incorporating the present invention;

FIG. 3 illustrates one specific embodiment of the present invention with liquid level indicated as a percentage value; and,

FIG. 4 illustrates an alternative embodiment of the present invention with liquid level indicated by a plurality of colored lights.

### DETAILED DESCRIPTION OF THE DRAWING FIGURES AND PREFERRED EMBODIMENTS

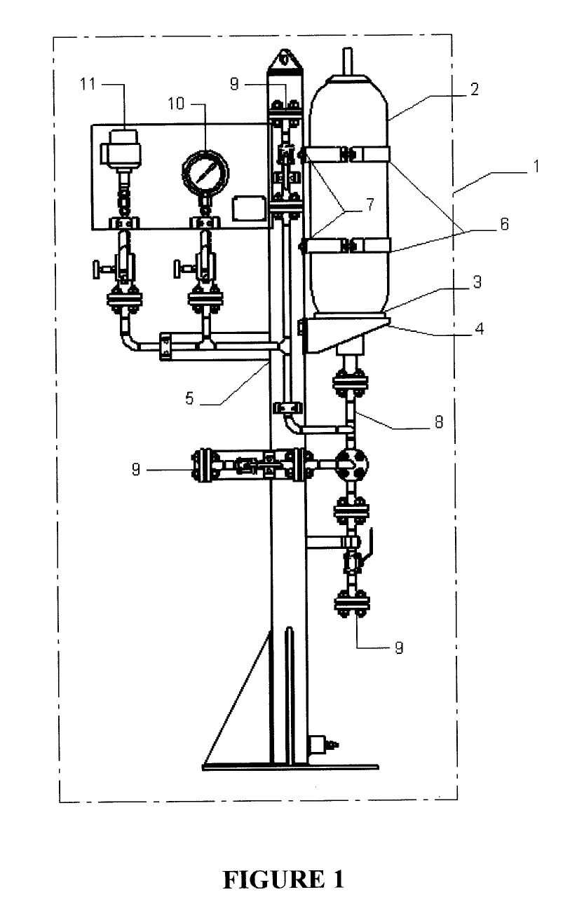

With reference to FIG. 1, the present invention relates to a pressure and temperature comparison device for use preferably with an API Plan 53B system 1. In a standard 53B system the vessel 2 is located on a cushion 3 and bracket 4, which in turn is fastened to a stand 5. Bracketing 6 is located circumferentially along the vessel 2 and connected, in turn, to the stand 5 at multiple juncture 7 to ensure that the vessel 2 is radially supported. Pipe work 8 connects the vessel to various outlets 9 and also pressure indicator 10 and transmitting device 11. The pressure device 10 indicates what pressure the barrier fluid resides at while the transmitting device 11 transmits the pressure reading to an external receiver, which can be connected to a central alarm system.

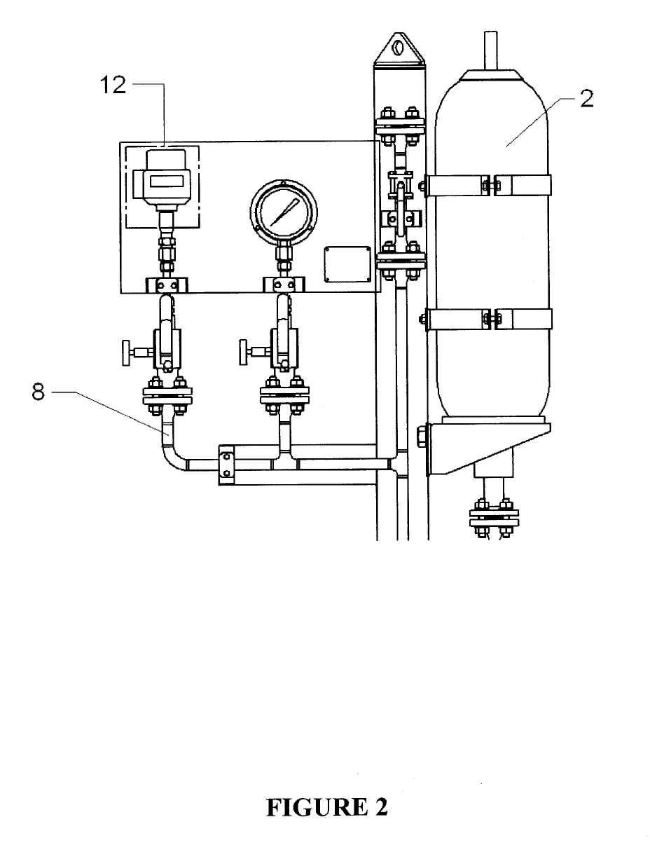

In the first preferred embodiment of the present invention illustrated in FIG. 2, the pressure transmitting device 11 is replaced by pressure and temperature measuring device 12. Device 12 measures the pressure and temperature of the liquid in the accumulator 2 and the pipe work 8. This combination allows a “floating alarm” that corrects the pressure reading to take into account the ambient temperature. The device 12 is programmed or adjusted to the parameters for the application through controls which reside on its body. The output of device 12 is used to trigger an alarm when refill is required. In this way, the device 12, in effect, measures the fill level of the liquid in the accumulator 2. A variety of visual indication methods can then be used to signal to the operator that refilling of the accumulator 2 with liquid is necessary, but also that the correct quantity of liquid has been added.

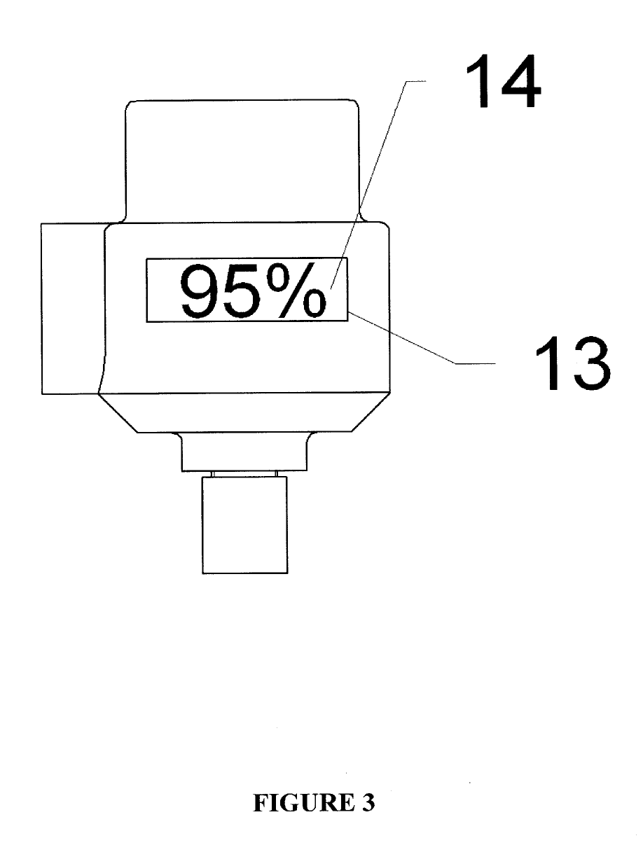

Referring to FIG. 3, a digital display 13 indicates the level of liquid that resides in the accumulator 2 shown as a percentage 14. Therefore the operator can determine when it is required to be refilled.

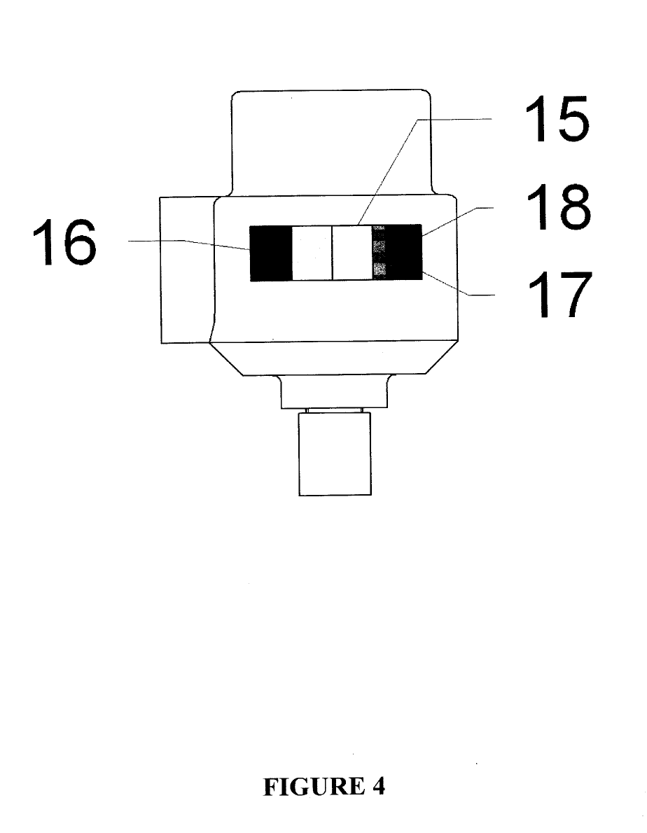

Referring to FIG. 4, a second series of colored lights 15 indicates the level of the liquid in said accumulator 2. The “fill me” level is indicated by a red light 16, while the charge pressure level is indicated by a green light 17.

While only several embodiments of the present invention have been shown and described, it will be obvious to those skilled in the art that many modifications may be made to the present invention without departing from the spirit and scope thereof.

What is claimed is:

1. A mechanical seal support system, comprising;
a hydro pneumatic bladder accumulator containing, when in use, a liquid;
means, responsive to temperature and pressure within said hydro pneumatic bladder accumulator, for generating an electrical signal indicative of volume of the liquid in said hydro pneumatic accumulator; and,
a display, in electrical communication with said means for generating an electrical signal, for receiving said electrical signal and providing a visual indication relating to the volume of the liquid.

2. The mechanical seal support system according to in claim 1, wherein said display provides a visual indication of a point at which the volume of the liquid within said hydro pneumatic bladder accumulator reaches a pre-determined low level or high level.

3. The mechanical seal system according to claim 2, wherein said low level of the liquid is indicated via a first colored light and the high level of the liquid is indicated via a second colored light with the first colored light and the second colored light having differing hews.

4. The mechanical seal system according to claim 2, wherein the low level of the liquid is indicated by a red light and the high level of the liquid is indicated by a green light and wherein an additional red light indicates when the pressure has exceeded the maximum operating pressure of the mechanical seal system.

5. The mechanical seal system according to claim 1, wherein the volume of liquid is indicated as a numerical percentage.

6. The mechanical seal system according to claim 1, wherein said means for generating an electrical signal is located externally of the hydro pneumatic bladder accumulator.

7. The mechanical seal system according to claim 6, further comprising pipe work connecting said means for signal generating an electrical signal to said hydro pneumatic bladder accumulator.

8. The mechanical seal system according to claim 1, wherein said means for generating an electrical signal is mounted on existing fittings in pipe work of an API Plan 53B system.
